(19) United States
(12) Patent Application Publication
(10) Pub. No.: US 2019/0002197 A1
(43) Pub. Date: Jan. 3, 2019

(54) DEVICE FOR PROLONGING THE STORAGE OF ORGANIC WASTE

(71) Applicant: 16EMEZZO SRL, Milano (IT)

(72) Inventor: Alessandro RUSSO, Casier (IT)

(21) Appl. No.: 16/064,006

(22) PCT Filed: Dec. 16, 2016
(86) PCT No.: PCT/IT2016/000299

§ 371 Date: Jun. 20, 2018

(30) Foreign Application Priority Data
Dec. 23, 2015 (IT) 102015000087246

(51) Int. Cl. B65F 1/06; B65F 1/08

(52) U.S. Cl. CPC B65F 1/06; B65F 2001/1489; B65F 1/08

(57) ABSTRACT

The device is formed by an external container (1) of strong airtight material and a second smaller inner container (3) storing the waste bag (4). The outer container (1) is equipped with an air-tight lid (8), an air suction pump (7) and a compensation pressure valve (10) to allow an easy opening of the lid (8).

The present patent application refers to the production of a compact household device to prolong the preservation of organic waste.

### BACKGROUND OF THE INVENTION

Organic waste is subject to separate waste collection and to separate treatment.

In homes organic waste is usually kept in kitchens, usually under sinks, stored in specific containers (kitchen waste bins) with biodegradable bags which are generally provided by utility companies dealing with waste collection, disposal and treatment.

Waste bins and bags are small having to be periodically sanitized, since waste liquid (known as leachate) leaches out of the waste bag caused by the decomposition of organic matter when garbage is not disposed of within 24-48 hours thus causing unpleasant odours and production of dirt.

This disadvantage occurs especially in summer and in warm climate areas throughout the year, where high temperatures accelerate the process of decomposition of organic matter.

The inevitable consequence is to have to dispose of the waste bag very frequently. In summer this occurs even daily unlike having to dispose of other type of waste (glass, plastic, metal and paper). Inorganic waste is disposed of weekly or fortnightly (even though its volume is generally much bigger) since it does not present the drawbacks of the above described deterioration.

This situation presents inconveniences:

For Families
disposing of waste very often (up to 4 to 5 times more frequently than for other sorted waste such as paper, plastic, glass, metal and unsorted inorganic waste). In other words organic waste must be transported to dumpsters or rubbish skips or bins for curbside pickup at least 3 times weekly (especially in summer)
needing to sanitize the waste bin very frequently because of formation of leachate that causes breakage of the biodegradable waste bags

For Utility Companies
collecting organic waste at least twice a week (which is more frequently than collecting all other types of waste, usually collected every 10/15/30 days) resulting in an economical burden and higher CO2 emissions from frequent transport
having to sanitize dumpsters or rubbish skips very frequently because of formation of leachate and unpleasant odours especially in summer and in warm climate areas

State of the art of known devices for household organic waste management:
devices for disintegration in sinks; such systems inevitably involve the sewer system thus possibly infringing the environmental eco-requirements
devices for compacting (by mechanical crushing) which reduces volume but does not slowdown the deterioration process of the organic matter;
refrigerating expensive devices that need a cumbersome and high energy consuming refrigerator;
total vacuum devices. Said systems require a one-shot residue treatment, that is, only when the container is full, in addition to the use of specific watertight bags. These solutions do not allow prolonged storage of organic waste during the period of progressive filling, which may last 2 or 3 days. In said systems, until the one shot vacuum process is not activated the deterioration of organic waste will normally proceed.

If vacuum-processing is not applied frequently, even if the container is not full, specific watertight bags must be used. The biodegradable bags decompose due to prolonged contact with organic waste and therefore tend to not maintain vacuum. These devices require small bins for collecting a maximum of about 2-3 days organic waste production. Example of such solutions are described in patent applications WO11001455 and WO13005236A1
centrifugation and dehydration systems that involve complex, expensive, bulky devices suitable for treating very large volumes of residue

State of the art of other known solutions are described below:
EP0209639 “Apparatus for compressing household refuse”

The invention described in patent EP0209639 describes a device for compressing household waste provided with a container where a bag, for containing the waste, is placed and with an air suction device.

Said invention described in patent EP0209639 contemplates the use of a conventional bag and the creation of depressurization by means of a pump, which is positioned outside the external container.

The device described in patent EP0209639 has the following disadvantages:
the system described in patent EP0209639 applies depressurization directly to the bag where the waste is stored thus making this application not feasible in the case of use of biodegradable bags, normally used for organic waste. Such biodegradable bags, because of their nature, decompose quickly, they are not air and water tight and they are not resistant to the pressure difference between the inside and the outside of the bag as described in patent EP0209639.
suction as described in patent EP0209639, occurs inside the bag itself; given the structural characteristics of a biodegradable bag, said solution implies that when a strong depressurization is applied, it will collapse within the container

In the case in which the bag is anchored to the container, in the case of strong depressurization, particularly during the first moments of waste delivery, when the bag is partially full, the waste bag would be sucked in by the suction pump.
the suction pump, as described in patent EP0209639, is positioned out of the container and linked to it by means of a duct.
U.S. Pat. No. 3,899,967 “Trash compactor”

The document describes a waste container equipped with a system for creating vacuum associated with the lid of said container.

The invention mode described in document U.S. Pat. No. 3,899,967 contemplates the use of a flexible container 10, in particular a bellows type to go along with the effect of a strong depressurization which aims at the reduction of the content volume of said bellows type container, resulting reinforced in the case of compression of materials such a glass or metal in order to ensure the resistance of the container itself.

The system needs a crush resistant waste bag, suitable for maintaining the pressure difference between the inside and the outside of the bag (66), which are not the characteristics of a biodegradable bag.
CA2852784 “vacuum food scraps and trash bin”

The solution described in document CA2852784 contemplates the delivery in a single large container, therefore not suitable for household use and vacuum occurs because of the mechanical action of a piston operated by the user. What described in document CA2852784 does not contemplate the use of the waste bags or the treatment of waste in the bags.

This solution would show the same drawbacks described in patent EP0209639 in the case of filling a single bag

The mechanical system described in both documents presents a number of drawbacks as the user might forget to trigger the piston, thus compromising the entire process.

Furthermore, the depressurization can never be considered identical depending on how much strain is applied to the piston by the user (an adult, a child, an elderly, a man or a woman); in addition the effort needed to be applied on the piston might be strong and elderly or weak people might not be able to create the sufficient depressurization to slow down the deterioration process.

The concept of a fully mechanical depressurization/pressurization system increases significantly the possible causes of air leaks due to the assembly of various mechanical components and seals.

A complex system, as the one described in document CA2852784, is delicate and holds out for a limited amount of time to the mechanical stresses operated during the pick-up phase. Similarly even a system based on an embodied electrically operated system would be exposed to the same risks of mechanical damage. It has to be considered in fact that the pick-up phase (both for organic and inorganic waste yin streets is mostly a mechanical process; the operator in a truck moves the container or dumpster close to the truck itself where the containers are hooked on to a mechanical arm that capsizes them to empty the content into the truck. This operation is not delicate and once upside down the container or dumpster is being shaken vigorously, 3 or 4 times by the mechanical arm to ensure complete emptying.

Said operation stresses the container and mostly the lid; this is being slammed putting at serious risk the electrical equipment (pump, valve, sensors, and photovoltaic panel)

Patent CA2852784 contemplates only one container, and therefore, in the case of mechanized emptying, it would be subject to the above mentioned drawbacks.

### SUMMARY OF THE INVENTION

The invention covered by this patent application allows to slow down the decomposition process of organic waste. It allows storage of said waste in a suitable container (household bin or rubbish dumpster) even for periods of 3 to 5 times longer if compared to the garbage disposing systems we are used to deal with today.

The invention covered by this patent application outdoes the disadvantages described above (state of the art devices) because:
it allows drastic reduction of the frequency of organic waste disposal bringing it to, or almost to, the level of other waste disposal frequency (i.e. plastic, glass, metal, paper and other inorganic)
it allows drastic reduction of the quantity of leachate, with the advantage of maintaining the biodegradable bags whole and not having to sanitize the bin frequently
it allows delay of organic waste deterioration since the first filling
it allows a continuous process of filling and usage of containers benefiting from the conservation method (the bin has to be filled several times, continuously until totally full)
the bin has to be emptied only once full and not whenever the organic waste comes to an advanced state of decomposition
the prolonged storage also allows the use of larger domestic bins compared to the current ones—(those provided by the utilities today are necessarily small), and therefore disposed of, with reduced frequency.
it can be easily and economically applied and managed on household bins and community collectors unlike the above described state of the art solutions
for utility companies the advantage is represented by a reduction in organic waste collection frequency level, bringing it to the level of the other types of waste, and by a reduction of sanitization frequency of bins (especially in summer) thus an economic benefit.

A further advantage of the device covered by the present patent application is the reduction of pollutants and CO2 emission coming from transport, resulting from the reduction of the collection frequency of the organic waste and reduced odors coming from dumpsters (especially in summer), those located in full sun and/or in warm climate areas.

### DESCRIPTION OF THE DRAWINGS

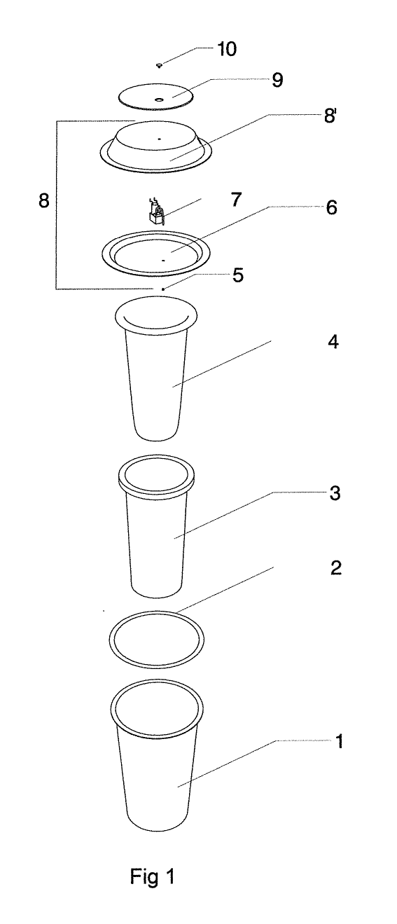

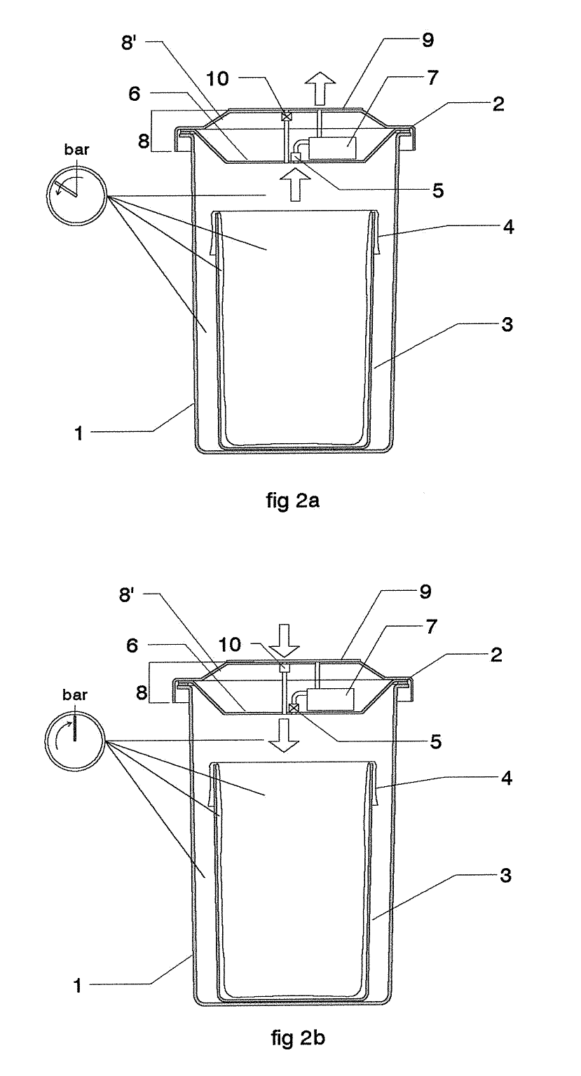

The invention disclosed in the present patent application is depicted in FIGS. 1, 2a and 2b attached hereto, where:

1—first container

2—seal

3—second container

4—biodegradable bag

5—valves

6—first component of the coverage assembly 8

7—suction pump

8—coverage assembly

8′—second component of the coverage assembly

9—photovoltaic panel

10—manually operated compensation valve

The invention disclosed in the present patent application proposes the use of the usual bin which has a first, container 1 for storing organic waste by allowing a delay of its deterioration thanks to a partial depressurization process of the inside volume.

The function of the internal container is to accomodate, contain and hold a biodegradable bag.

Therefore the depressurization takes place within the first container, which contains the second one, and the bag avoiding a pressure difference between the inside and the outside of the bag

In street bins it's the second container to be used for mechanical dumping.

The second container doesn't have the lid and the electrical equipment, it's lighter, not delicate and therefore suitable for a mechanized emptying process, for washing and sanitasing.

The length of preservation time of organic matter in a container depends on:
the combination of both internal temperature and internal pressure
the type of organic matter (differing in water content).

Organic matter deterioration causes changes to the molecular structure. Consequently water based liquid components leach out and are known as leachate. These components sink to the bottom of the waste bag generating bad odours due to putrefaction and causing the breakdown of the biodegradable bags due to prolonged contact between the bag and the liquid.

The invention disclosed in the present patent application aims to reduce the generation of leachate as much as possible through a process of partial removal of the air from inside the container.

In this way, by eliminating or reducing the amount of oxygen from inside the bin, thanks to an air suction pump, the oxidation process and therefore deterioration of organic matter are extremely slowed down. Consequently, the production of leachate is extremely reduced, its formation postponed

Users benefit from the additional time between drops as a result of the delay in leachate development.

In particular, during the warm season or in warm climate countries, the combination of climate conditions (higher air temperature and moisture) and composition of the organic waste (a higher water content due to a higher quantity of fruit and vegetables) exacerbates the problem because of bad odors, insect larvae and other inconveniences due to leakage of waste liquid from the garbage bags. This requires thorough washing of the containers after each delivery.

The invention disclosed in the present patent application is thus composed of a first container (1) and a second container (3) of hard material, smaller than the first container (1) resulting completely contained within the container (1) said container (3) accomodating a biodegradable waste bag (4); a coverage (8) which in turn is formed by a first component (6) and a second component (8′) concave adapted to create a container for accomodating the air suction pump (7). In the coverage system (6 and 8′) the lower component (6) is also provided with appropriate valves (5) and openings to allow and maintain depressurization inside the first container (1).

The activation of the air suction pump (7) creates depressurization in the first and second container(1, 3) that can vary between 0.15 and 0.75 bar; the seal (2) will allow to maintain the degree of depressurization created in the first container (1). Depressurization inside the first container (1) that accommodates the second container (3) causes a reduction of the presence and relative partial oxygen pressure present in the system first/second container (1, 3) itself thus slowing the process of deterioration of organic waste contained therein.

It is also known that lowering the atmospheric pressure in a watertight container causes the lowering of the boiling point of the liquids contained in it. In conditions of sufficiently high temperature, such as summer temperatures or sufficient exposure, to sunlight, (eg 0.2 bar and 60 degrees ° C.), the principle described for the device disclosed in the present patent application permits a partial evaporation of the water thus obtaining partial dehydration of the waste.

The invention disclosed in the present patent application differs from the ones above described (state of the art) for:
the suction device allows the partial air suction avoiding total vacuum;
the air suction mode controlled through an automatic on-off ignition system regulated by a pressure sensor. The air suction pump is reactivated whenever the container is opened to be filled until completely filled up;
as a direct consequence the possibility of opening and closing the container at each needed filling of organic waste;
the possibility of prolonging the conservation of organic waste even during continuous filling with new waste;
the possibility of applying the system also to street dumpsters or rubbish skips that are continuously filled with garbage bags

In addition the first container (1) is made out of suitable material and properly shaped to contrast the crushing induced by depressurization that will be created in it when the air suction pump (7) is activated.

The coverage assembly (8) is also equipped with a manually or electrically operated valve (10) which, at the opening, allows to re-establish the atmospheric pressure inside the first container (1) to allow the removal of the entire coverage assembly(8). The air suction pump (7) can be operated electrically or manually.

In the case of electrical operation measuring and control devices intended for the management of the operation may be provided.

When necessary the power can be supplied by a photovoltaic panel (9) or by an internal or external power supply.

The air suction pump (7) is powered by electrical energy that can come from a city supplier or from a photovoltaic panel applied to the container.

Any gases generated within, due to decomposition of organic matter will be removed by the air suction pump (7) which acts under the control of appropriate sensors for measuring the pressure inside the bin. Said sensors also allow the pump to stop once the inside pressure level, established to reduce electricity consumption and lengthen the operating life of the pump itself, is reached.

Containers of appropriate size equipped with what has previously been described in addition to being potentially equipped with photovoltaic panels for the power supply of the air suction pump (7), may be provided with an airtight compensation opening to allow maintenance of the internal depressurization during the filling of the bin. The pump will be automatically activated in order to compensate for any reduction in the internal depression due to the action of the loading mechanism.

1. A device to prolong the storage of domestic organic waste equipped with a first container (1), the device being provided with a second container (3) of hard material and smaller than the first container and a coverage (8);
said device being provided with a first lower component (6) and a second upper component (8′).
said second component (8′) being concave and accommodating an air suction pump (7) that can create a pressure between 0.15 and 0.75 bar in said first container (1),

2. A device according to claim 1 wherein the second component (6) is provided with a valve (5); said valve (5) can maintain the depressurization caused by the air suction pump (7).

3. A device according to claim 1, wherein the second component (8′) is provided with a valve (10); said valve (10) being able to re-establish atmospheric pressure inside the container (1).

4. A device according to claim 1, further comprising at least one seal (2).

5. A device according to claim 1, wherein the air suction pump (7) is powered by domestic electricity.

6. A device according to claim 1, wherein the air suction pump(7) is powered by a photovoltaic system (9).
